(19) United States
(12) Patent Application Publication
(10) Pub. No.: US 2019/0170443 A1
(43) Pub. Date: Jun. 6, 2019

(54) Circular Electric Furnace, and Electrode Arrangement Structure Thereof

(71) Applicant: BEIJING ZHONGKAIHONGDE TECHNOLOGY CO., LTD., Beijing (CN)

(72) Inventors: John Tung CHAO, Beijing (CN); Wenheng MU, Beijing (CN); Jibin LIU, Beijing (CN); Cunhu WANG, Beijing (CN); Lei CHEN, Beijing (CN); Han WEN, Beijing (CN)

(73) Assignee: Beijing Zhongkaihongde Technology Co., Ltd., Beijing (CN)

(21) Appl. No.: 16/304,650

(22) PCT Filed: May 15, 2017
(86) PCT No.: PCT/CN2017/084281

§ 371 Date: Nov. 26, 2018

(30) Foreign Application Priority Data
May 30, 2016 (CN) 201610371588.0
May 30, 2016 (CN) 201620509366.6

(51) Int. Cl. F27D 11/10; H05B 7/10; F27B 3/08; H05B 7/144

(52) U.S. Cl. CPC F27D 11/10; H05B 7/144; F27B 3/085; H05B 7/10

(57) ABSTRACT

The present disclosure provides a circular electric furnace, and electrode arrangement structure thereof. The electrode arrangement structure of the circular electric furnace comprises: 2n electrodes (11-16) and n single-phase transformers (40) each including two output ends, wherein the 2n electrodes (11-16) are respectively connected to the output ends of the n single-phase transformers (40), and n is an integer≥2. The electrode arrangement structure of the circular electric furnace of the present disclosure comprises 2n electrodes (11-16) and n single-phase transformers, with n≥2. That is, the structure comprises at least 4 electrodes and 2 single-phase transformers (40), and one single-phase transformer (40) is connected to two electrodes. In this way, the numbers of electrodes and transformers in the circular electric furnace are effectively increased, and the restriction of a conventional circular electric furnace which can only accommodate three electrodes and one transformer is eliminated, thus effectively increasing the electric power of a circular electric furnace.

The present application is a continuation of PCT/CN2017/084281 filed on May 15, 2017, entitled “Circular Electric Furnace, and Electrode Arrangement Structure Thereof” which claims priority to the Chinese patent application No. 2016103715880, filed with the Chinese Patent Office on May 30, 2016 and entitled “Circular Electric Furnace and Electrode Arrangement Structure”, and priority to the Chinese patent application No. 2016205093666, filed with the Chinese Patent Office on May 30, 2016 and entitled “Circular Electric Furnace and Electrode Arrangement Structure”, which are incorporated herein by reference in their entirety.

### TECHNICAL FIELD

The present disclosure relates to the technical field of smelting equipment, and particularly to an electrode arrangement structure of a circular electric furnace and a circular electric furnace comprising the electrode arrangement structure.

### BACKGROUND

At present, the traditional circular metallurgical alternating current electric furnaces or steel-making electric arc furnaces are all provided with three electrodes, and the lines connecting the centers of the three electrodes form an equilateral triangle. Such electrode arrangement structure has the following disadvantages: 1) due to being limited by the diameter of the electrodes, the current intensity becomes a bottleneck, and thus, the size of the transformer of the metallurgical electric furnace with three electrodes is limited and cannot be increased; and 2) in a circular metallurgical electric furnace with three electrodes, due to the occurrence of the induction electromagnetic force, the electric arcs repel each other, and the position thereof is biased towards the direction of the line connecting the center of the electric furnace and the center of the electrodes, so a Torx molten pool is formed, which does not facilitate the control of the feeding.

### SUMMARY

In order to solve at least one of the above technical problems, one object of the present disclosure is to provide an electrode arrangement structure of a circular electric furnace.

The other object of the present disclosure is to provide a circular electric furnace comprising the electrode arrangement structure.

In order to achieve the above objects, an embodiment of a first aspect of the present disclosure provides an electrode arrangement structure of a circular electric furnace, comprising: 2n electrodes and n single-phase transformers each including two output ends. The 2n electrodes are respectively connected to the output ends of the n single-phase transformers, and n is an integer≥2.

According to the first aspect of the present disclosure, the electrode arrangement structure of the circular electric furnace comprises 2n electrodes and n single-phase transformers, with n≥2. That is, the structure comprises at least 4 electrodes and 2 single-phase transformers, and one single-phase transformer is connected to two electrodes. In this way, the number of electrodes and the number of transformers in the circular electric furnace are effectively increased, and the restriction on a conventional circular electric furnace which can only accommodate three electrodes and one transformer is eliminated, thus effectively increasing the electric power of the circular electric furnace.

In addition, in the electrode arrangement structure of the circular electric furnace in the above embodiment of the present disclosure, n is 3.

N being 3 means that the electrode arrangement structure of the circular electric furnace comprises 6 electrodes and 3 single-phase transformers. Since one single-phase transformer is connected to two electrodes, the two electrodes connected to the same single-phase transformer are in-phase electrodes, and the current flowing therethrough is in-phase current. Thus, the 6 electrodes and the 3 single-phase transformers form a 3-phase 6-electrode electrode arrangement structure, which can be powered by three-phase alternating current. Since current intensity is sinusoidal with time, the three-phase alternating current can effectively average the current intensity such that the formed molten pool is more uniform. Of course, it should be understood by those skilled in the art that electrode arrangement structures in the form of 2 single-phase transformers and 4 electrodes, 4 single-phase transformers and 8 electrodes, etc. may also be provided according to the size of the inner space of the circular electric furnace, as long as there is enough space in the furnace chamber to accommodate these electrodes. These arrangements can always achieve the object of increasing the electric power of a circular electric furnace, without departing from the design idea and gist of the present disclosure, and therefore fall within the protection scope of the present disclosure.

In any of the technical solutions described above, six such electrodes are arranged in parallel along the circumference of the electric furnace.

In any of the technical solutions described above, the centers of six such electrodes are located on a single circle, which forms an electrode center circle of the six electrodes.

In any of the technical solutions described above, the center of the electrode center circle coincides with the center of the furnace chamber of the electric furnace.

The six electrodes are arranged in parallel in the circumferential direction of the electric furnace, then the molten pool formed by the six electrodes is also distributed in the circumferential direction of the electric furnace. Thus, the molten pool in the furnace chamber is relatively uniform and the load on the furnace wall is also relatively uniform, thereby preventing the occurrence of the case where the furnace wall at a certain location is seriously damaged due to severe erosion by high temperature melt flow. This effectively prolongs the service life of the furnace wall and further improves the safety and durability of the circular electric furnace. Further, the centers of the six electrodes are located on a single circle to form an electrode center circle, and in this way, the shape of the molten pool in the furnace chamber is closer to a circle. Therefore, the molten pool is more uniform and the load on the furnace wall is also more uniform. Preferably, the center of the electrode center circle coincides with the center of the furnace chamber of the electric furnace. In this way, the molten pool can be formed at the central position of the furnace chamber, thereby further ensuring the uniformity of the load on the furnace wall of the circular electric furnace and further improving the safety and durability of the circular electric furnace.

It should be explained that in an open-arc smelting system, the trend of electric arcs has high correlation with the flow of the molten pool and the safety of the furnace wall. In a conventional circular electric furnace, electric arcs repel each other. In order to reduce electrode consumption or operate with great power, it is necessary to increase the voltage. However, if the voltage is extremely high, the electric arcs will be very long, and sometimes the arc tails will burn the corresponding furnace wall. Therefore, domestic metallurgical furnaces generally avoid the operations with high voltage. However, if operations with low voltage are performed, high current will result in strong electric arc momentum, which will strike the surface of the molten pool in the direction of the furnace wall, causing slag with extremely high temperature to flow towards the furnace wall. If feeding is performed unevenly, the furnace wall is very likely to be eroded and damaged. Therefore, the arrangement of electrodes is very important, which does not only affect the formation of the molten pool, but also affects the trend of electric arcs. This has very great impact on the melt flow of the molten pool.

In any of the technical solutions described above, the two electrodes connected to the same single-phase transformer are in-phase electrodes, and the two electrodes being in-phase are arranged adjacent to each other.

To arrange the two electrodes being in-phase adjacent to each other makes, on the one hand, the 3-phase 6-electrode electrode arrangement structure correspond to a structure in which three independent single-phase electric furnaces are adjacent to one another without any furnace wall partition therebetween and share the molten pool, which effectively increases the electric power of a single electric furnace. On the other hand, this prevents the occurrence of the case where the power factor is greatly reduced due to mutual influence between out-of-phase electrodes resulting from cross arrangement. It should be explained that if two electrodes being in-phase are in cross arrangement, the phases affect each other and the trend of the electric arcs is not regular, which may lead to the generation of numerous harmonic waves and result in a great reduction in power factor.

In any of the technical solutions described above, the angles between the lines connecting the centers of two adjacent electrodes being out-of-phase with the center of the electrode center circle are β.

In any of the technical solutions described above, the angles between the lines connecting the centers of two adjacent electrodes being in-phase with the center of the electrode center circle are α, α+β=120°.

Since among the six electrodes forming a circle, two electrodes being in-phase are arranged adjacent to each other, the six electrodes form three pairs of adjacent in-phase electrodes and three pairs of adjacent out-of-phase electrodes, and thus, the lines connecting the centers of each pair of adjacent electrodes with the center of the electrode center circle form an angle therebetween. The reasons why the three angles formed between the lines connecting the centers of the three pairs of adjacent out-of-phase electrodes with the center of the electrode center circle are all set to β here are as follows: the electric arcs between out-of-phase electrodes attract each other while the electric arcs between in-phase electrodes repel each other, and thus, the three angles between the three pairs of out-of-phase electrodes being equal enables the electric arcs generated by the six electrodes to face each other and run uniformly along the circumference of the electric furnace, so that a uniform circular molten pool can be formed.

Further, the three angles formed between the lines connecting the centers of the three pairs of adjacent in-phase electrodes with the center of the electrode center circle are all α. Since 3α+3β=360°, α+β=120°, i.e., the sum of the angle α between the lines connecting the centers of two adjacent in-phase electrodes with the center of the electrode center circle and the angle β between the lines connecting the centers of two adjacent out-of-phase electrodes with the center of the electrode center circle is 120°. Thus, the six electrodes having 3 phases are symmetrically arranged in the circular electric furnace. In this way, the mutual interference between the three pairs of in-phase electrodes is more uniform, and therefore the generated electric arcs and the formed molten pool are more symmetrical and more uniform, so that the melt flow is consistent with respect to the circumferential furnace wall. Accordingly, the life of the furnace wall is prolonged and the safety and durability of the circular electric furnace are improved.

In any of the technical solutions described above, the ratio B/A of the distance B between the centers of two adjacent electrodes being out-of-phase to the distance A between the centers of two adjacent electrodes being in-phase is not smaller than 1.

In any of the technical solutions described above, the ratio B/A of the distance B between the centers of two adjacent electrodes being out-of-phase to the distance A between the centers of two adjacent electrodes being in-phase is greater than or equal to 1.1 and smaller than or equal to 1.3. The ratio B/A of the distance B between the centers of adjacent out-of-phase electrodes to the distance A between the centers of adjacent in-phase electrodes is set to be not smaller than 1. In other words, the distance B between the centers of adjacent out-of-phase electrodes is greater than the distance A between the centers of adjacent in-phase electrodes, in order to prevent the electric arcs between out-of-phase electrodes from excessively attracting each other and the formation of local high temperature zones. In this way, the electric arcs are evenly gathered between the two phases, so that a uniform circular molten pool can be formed in the circular electric furnace, thereby facilitating the control of the feeding. Moreover, by gathering the electric arcs between two phases, it is also possible to prevent the occurrence of the case where the electric arc tails sweep towards the furnace wall. Thus, the circular electric furnace can operate at a high voltage to reduce electrode loss, while it is also possible to prevent the high temperature melt flow from flowing towards the furnace wall. Preferably, B/A is greater than or equal to 1.1 and smaller than or equal to 1.3. In this way, it is possible to further improve the uniformity of the distribution of the electric arcs and thereby further improve the uniformity of the circular molten pool.

In any of the technical solutions described above, the ratio d/D of the diameter d of the electrode center circle to the inner diameter D of the furnace chamber is not greater than 0.5.

In any of the technical solutions described above, the ratio d/D of the diameter d of the electrode center circle to the inner diameter D of the furnace chamber is greater than or equal to 0.25 and smaller than or equal to 0.33.

The ratio d/D of the diameter d of the electrode center circle to the inner diameter D of the furnace chamber is set to be not greater than 0.5. In other words, the diameter d of the electrode center circle is smaller than half of the inner diameter D of the furnace chamber. On the one hand, this relatively increases the distance between the electrode and the furnace wall, thereby preventing the occurrence of the case where the electric arc tails sweep towards the furnace wall and burn the furnace wall. On the other hand, the molten pool can be effectively controlled to be formed in the central position of the furnace chamber, thus preventing the occurrence of the case where the high temperature melt flow flows towards the furnace wall to erode and damage the furnace wall. Therefore, the service life of the furnace wall is effectively prolonged and the safety and durability of the circular electric furnace is further improved. Preferably, d/D is greater than or equal to 0.25 and smaller than or equal to 0.33. In this way, it is possible to further prolong the service life of the furnace wall, thereby further improving the safety and durability of the circular electric furnace.

An embodiment of a second aspect of the present disclosure provides a circular electric furnace, comprising the electrode arrangement structure of the circular electric furnace as described in any one of the embodiments of the first aspect.

For the circular electric furnace provided by an embodiment of the second aspect of the present disclosure, since it is provided with the electrode arrangement structure of the circular electric furnace described in any one of the embodiments of the first aspect, the electric power of the circular electric furnace is effectively increased, and a uniform circular molten pool can be formed, which facilitates the control of the feeding. Also, the service life of the furnace wall is prolonged and the safety and durability of the circular electric furnace is improved.

Additional aspects and advantages of the present disclosure will become obvious from the following description, or will be understood by implementing the present disclosure.

### BRIEF DESCRIPTION OF DRAWINGS

The above and/or additional aspects and advantages of the present disclosure will become apparent and readily apparent from the description of embodiments in connection with the following drawings, in which:

FIG. 1 is a schematic diagram of an electrode arrangement structure of a circular electric furnace according to the present disclosure.

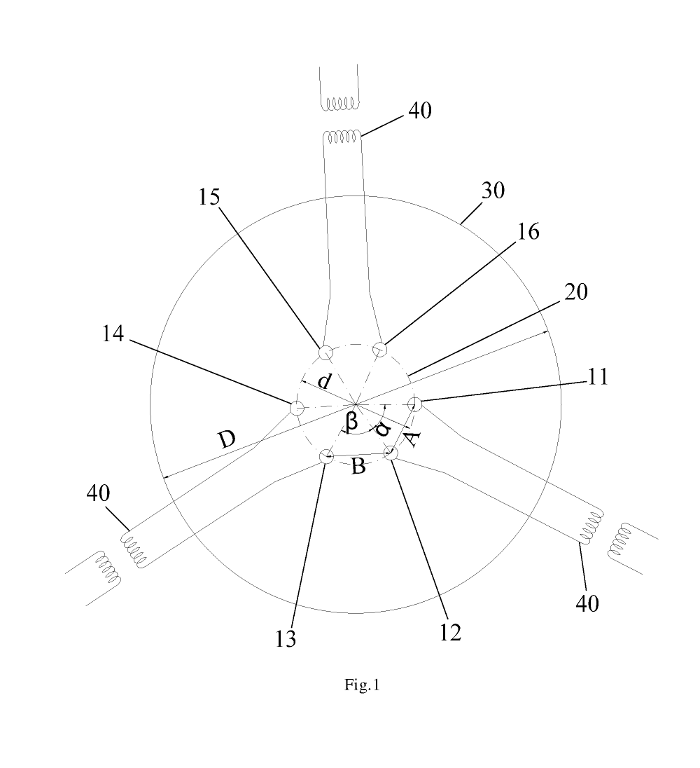

The correspondence relationship between the reference signs in FIG. 1 and the components is as follows:

11—first electrode, 12—second electrode, 13—third electrode, 14—fourth electrode, 15—fifth electrode, 16—sixth electrode, 20—electrode center circle, 30—furnace wall, and 40—single-phase transformer.

### DETAILED DESCRIPTION OF EMBODIMENTS

In order to understand the objects, features and advantages of the present disclosure more clearly, further detailed description is made on the present disclosure in connection with the embodiments with reference to the accompanying drawings. It should be noted that the embodiments of the present application and the features of the embodiments can be combined with each other if there is no conflict.

In the following description, numerous details are set forth to facilitate full understanding of the present disclosure. However, the present disclosure may also be implemented in other ways than those described herein. Thus, the protection scope of the present disclosure is not limited by the embodiments disclosed below.

Next, a circular electric furnace and an electrode arrangement structure thereof according to some embodiments of the present disclosure will be described with reference to FIG. 1.

FIG. 1 illustrates an electrode arrangement structure of a circular electric furnace provided in accordance with the first aspect of the present disclosure. As shown in FIG. 1, the electrode arrangement structure comprises 2n electrodes and n single-phase transformers 40.

Specifically, one single-phase transformer 40 includes two output ends, and the 2n electrodes are respectively connected to the output ends of the n single-phase transformers 40. In addition, n is an integer≥2.

The electrode arrangement structure of the circular electric furnace in accordance with the first aspect of the present disclosure comprises 2n electrodes and n single-phase transformers 40, with n≥2. That is, the structure comprises at least 4 electrodes and 2 single-phase transformers 40, and one single-phase transformer 40 is connected to two electrodes. In this way, the number of electrodes and the number of transformers in the circular electric furnace are effectively increased, and the restriction of a conventional circular electric furnace which can only accommodate three electrodes and one transformer is eliminated, thus effectively increasing the electric power of a circular electric furnace.

In some embodiments of the present disclosure, as shown in FIG. 1, n is 3.

In the above embodiment, n is 3. That is, the electrode arrangement structure of the circular electric furnace comprises 6 electrodes and 3 single-phase transformers 40. Since one single-phase transformer 40 is connected to two electrodes, the two electrodes connected to the same single-phase transformer 40 are in-phase electrodes, and the current flowing therethrough is in-phase current. Thus, the 6 electrodes and the 3 single-phase transformers 40 form a 3-phase 6-electrode electrode arrangement structure, which can be powered by three-phase alternating current. Since current intensity is sinusoidal with time, the current intensity can be effectively averaged by the three-phase alternating current such that the formed molten pool is more uniform.

It should be understood by those skilled in the art that electrode arrangement structures in the form of 2 single-phase transformers 40 and 4 electrodes, 4 single-phase transformers 40 and 8 electrodes, etc. may also be provided according to the size of the inner space of the circular electric furnace, as long as there is enough space in the furnace chamber to accommodate these electrodes, and these arrangements can always achieve the object of increasing the electric power of the circular electric furnace, without departing from the design idea and gist of the present disclosure, and therefore fall within the protection scope of the present disclosure.

Preferably, as shown in FIG. 1, six such electrodes are arranged in parallel along the circumference of the electric furnace.

More preferably, the centers of six such electrodes are located on a single circle, and the circle forms an electrode center circle 20 of the six electrodes.

More preferably, as shown in FIG. 1, the center of the electrode center circle 20 coincides with the center of the furnace chamber of the electric furnace.

The six electrodes are arranged in parallel in the circumferential direction of the electric furnace, and the molten pool formed by the six electrodes is also distributed in the circumferential direction of the electric furnace. Thus, the molten pool in the furnace chamber is relatively uniform and the load on the furnace wall 30 is also relatively uniform, thereby preventing the occurrence of the case where the furnace wall 30 at a certain location is seriously damaged due to severe erosion by high temperature melt flow. Therefore, the service life of the furnace wall 30 is effectively prolonged and the safety and durability of the circular electric furnace are further improved. Further, the centers of the six electrodes are located on a single circle to form an electrode center circle 20. In this way, the shape of the molten pool in the furnace chamber is closer to a circle. Therefore, the molten pool is more uniform and the load on the furnace wall 30 is also more uniform. Preferably, the center of the electrode center circle 20 coincides with the center of the furnace chamber of the electric furnace. As such, the molten pool can be formed at the central position of the furnace chamber, thereby further ensuring the uniformity of the load on the furnace wall 30 of the circular electric furnace and further improving the safety and durability of the circular electric furnace.

It should be explained that in an open-arc smelting system, the trend of electric arcs has high correlation with the flow of the molten pool and the safety of the furnace wall 30. In a conventional circular electric furnace, electric arcs repel each other. In order to reduce electrode consumption or operate with great power, it is necessary to increase the voltage. However, if the voltage is extremely high, the electric arcs will be very long, and sometimes the arc tails will burn the corresponding furnace wall 30. Therefore, domestic metallurgical furnaces generally avoid the operations with high voltage. However, if operations with low voltage are performed, high current will result in strong electric arc momentum, which will strike the surface of the molten pool in the direction of the furnace wall 30, causing slag with extremely high temperature to flow towards the furnace wall 30. If feeding is performed unevenly, the furnace wall 30 is very likely to be eroded and damaged. Therefore, the arrangement of electrodes is very important, which does not only affects the formation of the molten pool, but also affects the trend of electric arcs. This has very great impact on the melt flow of the molten pool.

In some embodiments of the present disclosure, as shown in FIG. 1, the two electrodes connected to the same single-phase transformer 40 are in-phase electrodes, and the two electrodes being in-phase are arranged adjacent to each other.

In the embodiment described above, to arrange the two electrodes being in-phase adjacent to each other makes, on the one hand, the 3-phase 6-electrode electrode arrangement structure correspond to a structure in which three independent single-phase electric furnaces are adjacent to one another without any partition of furnace wall 30 therebetween and share the molten pool, which effectively increases the electric power of a single electric furnace. On the other hand, this prevents the occurrence of the case where the power factor is greatly reduced due to mutual influence between out-of-phase electrodes resulting from cross arrangement. It should be explained that if two electrodes being in-phase are in cross arrangement, the phases affect each other and the trend of the electric arcs is not regular, which may lead to the generation of numerous harmonic waves and result in a great reduction in power factor.

In the embodiment described above, further, as shown in FIG. 1, the angles between the lines connecting the centers of two adjacent out-of-phase electrodes with the center of the electrode center circle 20 are β.

Further, as shown in FIG. 1, the angles between the lines connecting the centers of two adjacent in-phase electrodes with the center of the electrode center circle 20 are α, α+β=120°.

Since among the six electrodes forming a circle, two electrodes being in-phase are arranged adjacent to each other, the six electrodes form three pairs of adjacent in-phase electrodes and three pairs of adjacent out-of-phase electrodes, and thus, the lines connecting the centers of each pair of adjacent electrodes with the center of the electrode center circle 20 form an angle therebetween. The reasons why the three angles formed between the lines connecting the centers of the three pairs of adjacent out-of-phase electrodes with the center of the electrode center circle 20 are all set to β here are as follows: the electric arcs between out-of-phase electrodes attract each other while the electric arcs between in-phase electrodes repel each other, and thus, the three angles between the three pairs of out-of-phase electrodes being equal enables the electric arcs generated by the six electrodes to face each other and run uniformly along the circumference of the electric furnace, so that a uniform circular molten pool can be formed.

Further, the three angles formed between the lines connecting the centers of the three pairs of adjacent in-phase electrodes with the center of the electrode center circle 20 are all α. Since 3α+3β=360°, α+β=120°, i.e., the sum of the angle α between the lines connecting the centers of two adjacent in-phase electrodes with the center of the electrode center circle 20 and the angle β between the lines connecting the centers of two adjacent out-of-phase electrodes with the center of the electrode center circle 20 is 120°. Thus, the six electrodes having 3 phases are symmetrically arranged in the circular electric furnace. In this way, the mutual interference between the three pairs of in-phase electrodes is more uniform, and therefore the generated electric arcs and the formed molten pool are more symmetrical and more uniform, so that the melt flow is consistent with respect to the circumferential furnace wall 30. Accordingly, the life of the furnace wall 30 is prolonged and the safety and durability of the circular electric furnace are improved.

In the embodiment described above, further, the ratio B/A of the distance B between the centers of two adjacent electrodes being out-of-phase to the distance A between the centers of two adjacent electrodes being in-phase is not smaller than 1.

Preferably, the ratio B/A of the distance B between the centers of two adjacent electrodes being out-of-phase to the distance A between the centers of two adjacent electrodes being in-phase is greater than or equal to 1.1 and smaller than or equal to 1.3.

The ratio B/A of the distance B between the centers of adjacent out-of-phase electrodes to the distance A between the centers of adjacent in-phase electrodes is set to be not smaller than 1. In other words, the distance B between the centers of adjacent out-of-phase electrodes is greater than the distance A between the centers of adjacent in-phase electrodes, in order to prevent the electric arcs between out-of-phase electrodes from excessively attracting each other and in the formation of local high temperature zones. In this way, the electric arcs are evenly gathered between the two phases, so that a uniform circular molten pool can be formed in the circular electric furnace, thereby facilitating the control of the feeding. Moreover, by gathering the electric arcs between two phases, it is also possible to prevent the occurrence of the case where the electric arc tails sweep towards the furnace wall 30. Thus, the circular electric furnace can operate at a high voltage to reduce electrode loss, while it is also possible to prevent the high temperature melt flow from flowing towards the furnace wall 30. Preferably, B/A is greater than or equal to 1.1 and smaller than or equal to 1.3. In this way, it is possible to further improve the uniformity of the distribution of the electric arcs and thereby further improve the uniformity of the circular molten pool.

In the embodiment described above, further, the ratio d/D of the diameter d of the electrode center circle 20 to the inner diameter D of the furnace chamber is not greater than 0.5.

Preferably, the ratio d/D of the diameter d of the electrode center circle 20 to the inner diameter D of the furnace chamber is greater than or equal to 0.25 and smaller than or equal to 0.33.

The ratio d/D of the diameter d of the electrode center circle 20 to the inner diameter D of the furnace chamber is set to be not greater than 0.5. In other words, the diameter d of the electrode center circle 20 is smaller than half of the inner diameter D of the furnace chamber. On the one hand, this relatively increases the distance between the electrode and the furnace wall 30, thereby preventing the occurrence of the case where the electric arc tails sweep towards the furnace wall 30 and burn the furnace wall 30. On the other hand, the molten pool can be effectively controlled to be formed in the central position of the furnace chamber, thus preventing the occurrence of the case where the high temperature melt flow flows towards the furnace wall 30 to erode and damage the furnace wall 30. Therefore, the service life of the furnace wall 30 is effectively prolonged and the safety and durability of the circular electric furnace is further improved. Preferably, d/D is greater than or equal to 0.25 and smaller than or equal to 0.33. In this way, it is possible to further prolong the service life of the furnace wall 30, thereby further improving the safety and durability of the circular electric furnace.

The electrode arrangement structure of the circular electric furnace of the present disclosure will be described in detail below in connection with some embodiments of the present disclosure.

### First Embodiment

As shown in FIG. 1, the electrode arrangement structure of the circular electric furnace comprises three single-phase transformers 40 and six electrodes. The six electrodes are arranged in parallel in the circumferential direction of the electric furnace, and the centers of the six electrodes are located on a single circle, i.e., located on the electrode center circle 20. The center of the electrode center circle 20 coincides with the center of the furnace chamber of the electric furnace. Two electrodes being in-phase are arranged adjacent to each other. The first electrode 11 and the second electrode 12 form a first phase, the third electrode 13 and the fourth electrode 14 form a second phase, and the fifth electrode 15 and the sixth electrode 16 form a third phase. Moreover, the angles between the lines connecting the centers of the adjacent in-phase electrodes with the center of the electrode center circle 20 are equal and dented as α, and the angles between the lines connecting the centers of the adjacent out-of-phase electrodes with the center of the electrode center circle 20 are equal and denoted as β, α+β=120°. The distance between the centers of adjacent in-phase electrodes is denoted as A, and the distance between the centers of adjacent out-of-phase electrodes is denoted as B.

The power of each single-phase transformer 40 is 25 MVA, the diameter d of the electrode center circle 20 is 3.9 meters, and the inner diameter D of the furnace chamber is 13.6 meters. Thus, d/D≈0.29. In addition, A is 1.77 meters and B is 2.13 meters, and thus, B/A≈1.2. Moreover, α is 54° and β is 66°.

### Second Embodiment

The second embodiment differs from the first embodiment in that: the power of each single-phase transformer 40 is 12 MVA, the diameter d of the electrode center circle 20 is 2.6 meters, and the inner diameter D of the furnace chamber is 9.1 meters. Thus, d/D≈0.29. In addition, A is 1.24 meters and B is 1.36 meters, and thus, B/A≈1.1. Moreover, α is 57° and β is 63°.

### Third Embodiment

The third embodiment differs from the first embodiment in that: the power of each single-phase transformer 40 is 18 MVA, the diameter d of the electrode center circle 20 is 3.52 meters, and the inner diameter D of the furnace chamber is 12.3 meters. Thus, d/D≈0.29. In addition, A is 1.53 meters and B is 1.98 meters, and thus, B/A≈1.3. Moreover is 51° and β is 69°.

### Fourth Embodiment IV

The fourth embodiment differs from the first embodiment in that: the power of each single-phase transformer 40 is 30 MVA, the diameter d of the electrode center circle 20 is 3.9 meters, and the inner diameter D of the furnace chamber is 15.58 meters. Thus, d/D≈0.25. In addition, A is 1.77 meters and B is 2.13 meters, and thus, B/A≈1.2. Moreover is 54° and β is 66°.

### Fifth Embodiment

The fifth embodiment differs from the first embodiment in that: the power of each single-phase transformer 40 is 45 MVA, the diameter d of the electrode center circle 20 is 3.52 meters, and the inner diameter D of the furnace chamber is 10.68 meters. Thus, d/D≈0.33. In addition, A is 1.53 meters and B is 1.98 meters, and thus, B/A≈1.3. Moreover, α is 51° and β is 69°.

### Sixth Embodiment

The sixth embodiment differs from the first Embodiment in that: the power of each single-phase transformer 40 is 5 MVA, the diameter d of the electrode center circle 20 is 3 meters, and the inner diameter D of the furnace chamber is 6 meters. Thus, d/D≈0.5. In addition, A is 1.43 meters and B is 1.57 meters, and thus, B/A≈1.1. Moreover, α is 57° and β is 63°.

### Seventh Embodiment

The seventh embodiment differs from the first embodiment in that: the power of each single-phase transformer 40 is 5 MVA, the diameter d of the electrode center circle 20 is 3 meters, and the inner diameter D of the furnace chamber is 6 meters. Thus, d/D≈0.5. In addition, A is 1.5 meters and B is 1.5 meters, and thus, B/A≈1. Moreover, α is 60° and β is 60°.

The above embodiments all have the following advantageous effects. Uniform circular molten pool is formed at the central position of the circular alternating current electric furnace. Since there are six electrodes, it is possible to use three single-phase transformers 40, thereby effectively increasing the electric power of the electric furnace.

The circular electric furnace provided in accordance with the second aspect of the present disclosure comprises the electrode arrangement structure of the circular electric furnace as described in any one of the embodiments of the first aspect.

For the circular electric furnace in accordance with the second aspect of the present disclosure, since it is provided with the electrode arrangement structure of the circular electric furnace described in any one of the embodiments of the first aspect, the electric power of the circular electric furnace is effectively increased, and a uniform circular molten pool can be formed, which facilitates the control of the feeding, and also prolongs the service life of the furnace wall 30 and improves the safety and durability of the circular electric furnace.

In summary, the electrode arrangement structure of a circular electric furnace in accordance with the present disclosure comprises 2n electrodes and n single-phase transformers, with n≥2. In other words, the structure comprises at least 4 electrodes and 2 single-phase transformers, and one single-phase transformer is connected to two electrodes. In this way, the number of electrodes and the number of transformers in the circular electric furnace are effectively increased, and the restriction of a conventional circular electric furnace which can only accommodate three electrodes and one transformer is eliminated, thus effectively increasing the electric power of a circular electric furnace. In the present disclosure, the terms “first” and “second” only serve the purpose of description, but cannot be construed as an indication or suggestion of relative importance. The term “a plurality of” refers to “two or more”, unless otherwise explicitly defined. The terms such as “install”, “link”, “connect” and “fix” shall all be understood in broad sense. For example, the term “connect” may refer to fixed connection, detachable connection or integral connection. The term “link” may refer to direct connection or indirect connection by means of an intermediate medium. Those of ordinary skills in the art could understand the specific meaning of the terms in the present disclosure according to specific situations.

In the description of this specification, the terms “one embodiment”, “some embodiments”, “specific embodiments”, etc., means that specific features, structures, materials or characteristics described in connection with the embodiments or examples are included in at least one embodiment or example of the present disclosure. In this specification, schematic representations of the above terms do not necessarily refer to the same embodiments or examples. Moreover, the specific features, structures, materials or characteristics described may be combined in any one or more embodiments or examples in a suitable manner.

The description above is merely preferred embodiments of the present disclosure, which are not used to limit the present disclosure. For those skilled in the art, various changes and variations may be made to the present disclosure. Any modifications, equivalent substitutions, improvements etc. within the spirit and principle of the present disclosure shall all be included in the scope of protection of the present disclosure.

1. An electrode arrangement structure of a circular electric furnace, characterized by comprising:
2n electrodes; and
n single-phase transformers each including two output ends, the 2n electrodes being respectively connected to the output ends of the n single-phase transformers,
wherein n is an integer≥2.

2. The electrode arrangement structure of the circular electric furnace according to claim 1, characterized in that,
n is 3.

3. The electrode arrangement structure of the circular electric furnace according to claim 2, characterized in that,
six electrodes are arranged in parallel along the circumference of the electric furnace.

4. The electrode arrangement structure of the circular electric furnace according to claim 3, characterized in that,
the centers of six electrodes are located on a single circle, which forms an electrode center circle of the six electrodes.

5. The electrode arrangement structure of the circular electric furnace according to claim 4, characterized in that,
the center of the electrode center circle coincides with the center of a furnace chamber of the electric furnace.

6. The electrode arrangement structure of the circular electric furnace according to claim 4, characterized in that,
the two electrodes connected to the same single-phase transformer are in-phase electrodes, and the two electrodes being in-phase are arranged adjacent to each other.

7-13. (canceled)

14. The electrode arrangement structure of the circular electric furnace according to claim 5, characterized in that,
the two electrodes connected to the same single-phase transformer are in-phase electrodes, and the two electrodes being in-phase are arranged adjacent to each other.

15. The electrode arrangement structure of the circular electric furnace according to claim 6, characterized in that,
the angles between the lines connecting the centers of two adjacent electrodes being out-of-phase with the center of the electrode center circle are all β.

16. The electrode arrangement structure of the circular electric furnace according to claim 14, characterized in that,
the angles between the lines connecting the centers of two adjacent electrodes being out-of-phase with the center of the electrode center circle are all β.

17. The electrode arrangement structure of the circular electric furnace according to claim 15, characterized in that,
the angles between the lines connecting the centers of two adjacent electrodes being in-phase with the center of the electrode center circle are all α, α+β=120°.

18. The electrode arrangement structure of the circular electric furnace according to claim 16, characterized in that,
the angles between the lines connecting the centers of two adjacent electrodes being in-phase with the center of the electrode center circle are all α, α+β=120°.

19. The electrode arrangement structure of the circular electric furnace according to claim 17, characterized in that,
the ratio B/A of the distance B between the centers of two adjacent electrodes being out-of-phase to the distance A between the centers of two adjacent electrodes being in-phase is not smaller than 1.

20. The electrode arrangement structure of the circular electric furnace according to claim 18, characterized in that,
the ratio B/A of the distance B between the centers of two adjacent electrodes being out-of-phase to the distance A between the centers of two adjacent electrodes being in-phase is not smaller than 1.

21. The electrode arrangement structure of the circular electric furnace according to claim 19, characterized in that,
the ratio B/A of the distance B between the centers of two adjacent electrodes being out-of-phase to the distance A between the centers of two adjacent electrodes being in-phase is greater than or equal to 1.1 and smaller than or equal to 1.3.

22. The electrode arrangement structure of the circular electric furnace according to claim 20, characterized in that,
the ratio B/A of the distance B between the centers of two adjacent electrodes being out-of-phase to the distance A between the centers of two adjacent electrodes being in-phase is greater than or equal to 1.1 and smaller than or equal to 1.3.

23. The electrode arrangement structure of the circular electric furnace according to claim 5, characterized in that,
the ratio d/D of the diameter d of the electrode center circle to the inner diameter D of the furnace chamber is not greater than 0.5.

24. The electrode arrangement structure of the circular electric furnace according to claim 23, characterized in that,
the ratio d/D of the diameter d of the electrode center circle to the inner diameter D of the furnace chamber is greater than or equal to 0.25 and smaller than or equal to 0.33.

25. A circular electric furnace, characterized by comprising the electrode arrangement structure of the circular electric furnace according to claim 1.

26. A circular electric furnace, characterized by comprising the electrode arrangement structure of the circular electric furnace according to claim 2.
